(19) United States
(12) Patent Application Publication
(10) Pub. No.: US 2026/0178714 A1
(43) Pub. Date: Jun. 25, 2026

(54) APPARATUS CONTROL DEVICE, APPARATUS CONTROL METHOD, AND AUTHENTICATION METHOD

(71) Applicant: NEC Corporation, Minato-ku, Tokyo (JP)

(72) Inventors: Koyo SHIBATA, Tokyo (JP); Kazuki Inagaki, Tokyo (JP); Yuta Shimizu, Tokyo (JP)

(73) Assignee: NEC Corporation, Minato-ku, Tokyo (JP)

(21) Appl. No.: 18/728,877

(22) PCT Filed: Mar. 30, 2022
(86) PCT No.: PCT/JP2022/015897

§ 371 Date: Jul. 14, 2024

(51) Int. Cl. G06F 21/32; G06F 21/31

(52) U.S. Cl. CPC G06F 21/32; G06F 21/31

(57) ABSTRACT

Unification means determines whether or not a first user who has succeeded in authentication performed by first authentication means in regard to the operation of a first apparatus and a second user who has succeeded in authentication performed by second authentication means in regard to the operation of a second apparatus are the same person. When the unification means determines that the first and second users are the same person, it determines that the second user has already succeeded in the authentication by the first authentication means.

### TECHNICAL FIELD

The present disclosure relates to an apparatus control device, an authentication device, a method, and a computer readable medium.

### BACKGROUND ART

A technology by which a vehicle can be used by using biometric information instead of using a key has been known. As a related technology, Patent Literature 1 discloses an authentication device for a vehicle. In the authentication device for a vehicle disclosed in Patent Literature 1, two or more types of biometric authentication can be performed. Specifically, in the authentication device for a vehicle, it is possible to perform face authentication as first biometric authentication and then perform vein authentication as second biometric authentication. An ECU (Electric Control Unit) for controlling the vehicle unlocks a door of the vehicle when the first biometric authentication has succeeded. An engine ECU permits the engine to be started when the second biometric authentication has succeeded.

### CITATION LIST

### Patent Literature

Patent Literature 1: Japanese Unexamined Patent Application Publication No. 2007-145200

### SUMMARY OF INVENTION

### Technical Problem

Biometric authentication has an advantage that stealing and disguising are difficult, and it is also very convenient. Multimodal biometric authentication can improve security by combining a plurality of types of biometric authentication. For example, assume that the false acceptance rate of first biometric authentication is 1/10,000 and that of second biometric authentication is 1/10,000. In this case, the probability that a stranger passes the first and second biometric authentication at the same time is 1/100,000,000 (1/10,000×1/10,000=1/100,000,000).

However, Patent Literature 1 does not give any consideration to a case where a person who unlocks the door is different from a person who starts the engine. For example, when an automobile is used, a person other than the driver may unlock the door through face authentication, and the person may get in the vehicle. In that case, a person other than the person who has unlocked the door may sit on the driver's seat and perform vein authentication. In this case, the driver performs only the vein authentication. Therefore, in Patent Literature 1, the engine may be permitted to be started in response to the result of only one type of biometric authentication. That is, the biometric authentication of the driver may not be multimodal.

In view of the above-described circumstances, an object of the present disclosure is to provide an apparatus control device, an authentication device, methods for them, and a computer readable medium for enabling a specific apparatus to be operated only when two or more types of biometric authentication have succeeded.

### Solution to Problem

To achieve the above-described object, as a first aspect, the present disclosure provides an apparatus control device. The apparatus control device includes: control means for controlling a first apparatus and a second apparatus;

first authentication means for authenticating a user by using first biometric information; second authentication means for authenticating a user by using second biometric information; and unification means for unifying an authentication result of the first authentication means with an authentication result of the second authentication means. In the apparatus control device, the control means permits the first apparatus to be operated when the user has succeeded in the authentication by the first authentication means, and permits the second apparatus to be operated when the user has succeeded in the authentication by the first authentication means and succeeded in the authentication by the second authentication means. The first authentication means performs the authentication of the user in regard to the operation of the first apparatus. The second authentication means performs the authentication of the user in regard to the operation of the second apparatus. The unification means determines whether or not a first user who has succeeded in the authentication performed by the first authentication means in regard to the operation of the first apparatus and a second user who has succeeded in the authentication performed by the second authentication means in regard to the operation of the second apparatus are the same person, and determines that the second user has already succeeded in the authentication by the first authentication means when it is determined that the first and second users are the same person.

As a second aspect, the present disclosure provides an authentication device. The authentication device includes: first authentication means for authenticating a user in regard to an operation of a first apparatus by using first biometric information; second authentication means for authenticating a user in regard to an operation of a second apparatus by using second biometric information; and unification means for unifying an authentication result of the first authentication means with an authentication result of the second authentication means. The first apparatus is an apparatus that is permitted to be operated when the first authentication means has succeeded in the authentication. The second apparatus is an apparatus that is permitted to be operated when the first authentication means has succeeded in the authentication and the second authentication means has succeeded in the authentication. In the authentication device, the unification means determines that, when a first user who has succeeded in the authentication performed by the first authentication means in regard to the operation of the first apparatus and a second user who has succeeded in the authentication performed by the second authentication means in regard to the operation of the second apparatus are the same person, the second user has already succeeded the authentication by the first authentication means.

As a third aspect, the present disclosure provides an apparatus control method. The apparatus control method includes: authenticating a user in regard to an operation of a first apparatus by using first biometric information; permitting the user to operate the first apparatus when the user has succeeded in the authentication using the first biometric information; authenticating a user in regard to an operation of a second apparatus by using second biometric information; determining whether or not a first user who has succeeded in the authentication performed in regard to the operation of the first apparatus by using the first biometric information and a second user who has succeeded in the authentication performed in regard to the operation of the second apparatus by using the second biometric information are the same person; and permitting the second user to operate the second apparatus when it is determined the first and second users are the same person.

As a fourth aspect, the present disclosure provides an authentication method. The authentication method includes: authenticating a user in regard to an operation of a first apparatus by using first biometric information, the first apparatus being configured to be permitted to be operated when the authentication using the first biometric information has succeeded; authenticating a user in regard to an operation of a second apparatus by using second biometric information, the second apparatus being configured to be permitted to be operated when the authentication using the first biometric information and the authentication using the second biometric information have succeeded; determining whether or not a first user who has succeeded in the authentication performed in regard to the operation of the first apparatus by using the first biometric information and a second user who has succeeded in the authentication performed in regard to the operation of the second apparatus by using the second biometric information are the same person; and determining that the second user has already succeeded in the authentication using the first biometric information when it is determined the first and second users are the same person.

As a fifth aspect, the present disclosure provides a computer readable medium. The computer readable medium stores a program for causing a computer to perform processes including: authenticating a user in regard to an operation of a first apparatus by using first biometric information; permitting the user to operate the first apparatus when the user has succeeded in the authentication using the first biometric information; authenticating a user in regard to an operation of a second apparatus by using second biometric information; determining whether or not a first user who has succeeded in the authentication performed in regard to the operation of the first apparatus by using the first biometric information and a second user who has succeeded in the authentication performed in regard to the operation of the second apparatus by using the second biometric information are the same person; and permitting the second user to operate the second apparatus when it is determined the first and second users are the same person.

As a sixth aspect, the present disclosure provides a computer readable medium. The computer readable medium stores a program for causing a computer to perform processes including: authenticating a user in regard to an operation of a first apparatus by using first biometric information, the first apparatus being configured to be permitted to be operated when the authentication using the first biometric information has succeeded; authenticating a user in regard to an operation of a second apparatus by using second biometric information, the second apparatus being configured to be permitted to be operated when the authentication using the first biometric information and the authentication using the second biometric information have succeeded; determining whether or not a first user who has succeeded in the authentication performed in regard to the operation of the first apparatus by using the first biometric information and a second user who has succeeded in the authentication performed in regard to the operation of the second apparatus by using the second biometric information are the same person; and determining that the second user has already succeeded in the authentication using the first biometric information when it is determined the first and second users are the same person.

### Advantageous Effects of Invention

The apparatus control device, the authentication device, the methods for them, and the computer readable medium according to the present disclosure enable a user to operate a specific apparatus only when two or more types of biometric authentication have succeeded.

### BRIEF DESCRIPTION OF DRAWINGS

FIG. 1 is a block diagram showing an example of a general configuration of an apparatus control device according to the present disclosure;

FIG. 2 is a block diagram showing an example of a configuration of an apparatus control device according to an example embodiment of the present disclosure;

FIG. 3 is a flowchart showing a procedure of operations performed by an apparatus control device when a lock of a door is unlocked;

FIG. 4 is a flowchart showing a procedure of operations performed by an apparatus control device when an engine is started; and

FIG. 5 is a block diagram showing an example of a physical configuration of an apparatus control device.

### EXAMPLE EMBODIMENT

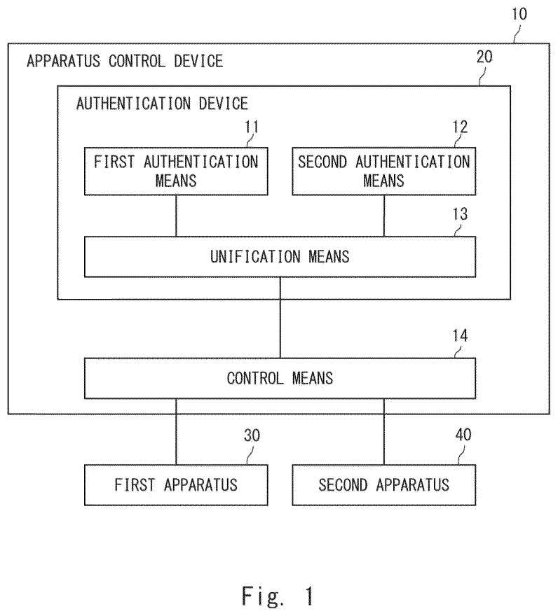

Prior to describing an example embodiment according to the present disclosure, an overview of the present disclosure will be described. FIG. 1 shows a general configuration of an apparatus control device according to the present disclosure. An apparatus control device 10 includes first authentication means 11, second authentication means 12, unification means 13, and control means 14.

The first authentication means 11 authenticates a user by using first biometric information. The second authentication means 12 authenticates a user by using second biometric information. The unification means 13 unifies the result of the authentication by the first authentication means 11 with that of the authentication by the second authentication means 12. The first authentication means 11, the second authentication means 12, and the unification means 13 constitute an authentication device 20.

The control means 14 controls a first apparatus 30 and a second apparatus 40. The control means 14 permits a user to operate the first apparatus 30 when the user has succeeded in the authentication by the first authentication means 11. Further, the control means 14 permits a user to operate the second apparatus 40 when the user has succeeded in the authentication by the first authentication means 11 and succeeded in the authentication by the second authentication means 12.

The first authentication means 11 authenticates a user in regard to the operation of the first apparatus 30. The second authentication means 12 authenticates a user in regard to the operation of the second apparatus 40. The unification means 13 determines whether or not a first user who has succeeded in the authentication performed by the first authentication means 11 in regard to the operation of the first apparatus 30 and a second user who has succeeded in the authentication performed by the second authentication means 12 in regard to the operation of the second apparatus 40 are the same person. When the unification means 13 determines that the first and second users are the same person, it determines that the second user has already succeeded in the authentication by the first authentication means 11.

According to the present disclosure, the unification means 13 determines that the second user has already been authenticated by the first authentication means 11 when the first user who has been authenticated when he/she operated the first apparatus 30 and the second user are the same person when he/she operates the second apparatus 40. Even when the second user has not been authenticated by the first authentication means 11 when he/she operates the second apparatus 40, the control means 14 permits the second user to operate the second apparatus 40 because the second user has already been authenticated by the first authentication means 11 when he/she operated the first apparatus 30. When the first and second users are not the same person, the first authentication means 11 can perform authentication for the second user. The control means 14 can permit the second user to operate the second apparatus 40 when the second user has been authenticated by the first authentication means 11.

According to the present disclosure, for example, when a user who has been authenticated when he/she operated the first apparatus 30 operates the second apparatus 40, the authentication of the user by the first authentication means 11 can be omitted when he/she operates the second apparatus 40. Even in this case, the biometric authentication is multimodal because the user has already succeeded in the authentication by the first authentication means 11 when he/she operated the first apparatus 30. The apparatus control device 10 according to the present disclosure can permit a user to operate the second apparatus 40 when two or more types of biometric authentication have succeeded. According to the present disclosure, since a plurality of types of biometric authentication are used for the operation of the second apparatus 40, the security can be improved. According to the present disclosure, when a user has already succeeded in the authentication by the first authentication means 11 when he/she operated the first apparatus 30, there is no need to perform the authentication by the first authentication means 11 again when the user operates the second apparatus 40. Therefore, it is possible to maintain the multimodal biometric authentication and improve the usability for users.

An example embodiment according to the present disclosure will be described hereinafter in detail with reference to the drawings. Note that the following descriptions and drawings have been omitted and simplified as appropriate for clarifying the explanation. Further, the same or similar elements are assigned the same reference numerals (or symbols) throughout the drawings, and redundant descriptions thereof are omitted as appropriate.

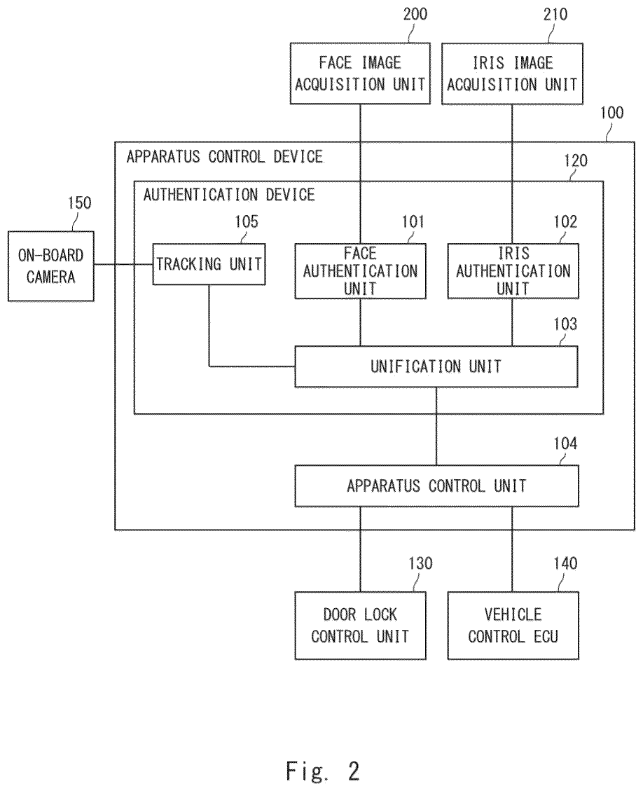

FIG. 2 shows an apparatus control device 100 according to an example embodiment of the present disclosure. The apparatus control device 100 includes a face authentication unit 101, an iris authentication unit 102, a unification unit 103, an apparatus control unit 104, and a tracking unit 105. In the apparatus control device 100, the face authentication unit 101, the iris authentication unit 102, the unification unit 103, and the tracking unit 105 constitute an authentication device 120. The apparatus control device 100 is formed as, for example, a device including at least one processor and at least one memory. At least some of the functions of the units in the apparatus control device 100 may be implemented by having a processor perform a process according to a program read from the memory.

In this example embodiment, it is assumed that the apparatus control device 100 is installed, for example, in a vehicle and controls the operations of a plurality of apparatuses of the vehicle. The vehicle may be, for example, a mobile object such as a passenger car, a taxi, or a van. In this example embodiment, the vehicle can be used by a plurality of users. Examples of apparatuses to be controlled, controlled by the apparatus control device 100 include an apparatus provided in the vehicle or operated by an occupant when he/she drives the vehicle. Examples of apparatuses to be controlled include apparatuses such as an engine (main switch), a power window, a horn, a door lock, and an air conditioner. Examples of apparatuses to be controlled may also include display audio (DA) and on-board apparatuses such as a car navigation device.

In this example embodiment, the apparatuses operated by the apparatus control device 100 include a door lock control unit 130 and a vehicle control ECU 140. The door lock control unit 130 controls a lock provided in each door of the vehicle. For example, the door lock control unit 130 may individually lock or unlock each door, or may lock or unlock all doors at once. The vehicle control ECU 140 controls apparatuses related to the driving of the vehicle. The vehicle control ECU 140 can start the engine of the vehicle or start the driving system of the vehicle. The apparatus control device 100 corresponds to the apparatus control device 10 shown in FIG. 1. The door lock control unit 130 and the vehicle control ECU 140 correspond to the first apparatus 30 and the second apparatus 40, respectively, shown in FIG. 1.

In this example embodiment, the apparatus control device 100 controls the operations of apparatuses to be controlled by using a plurality of types of biometric authentication. In this example embodiment, face authentication and iris authentication are used as authentication using biometric information. The apparatus control device 100 permits a user to operate an apparatus that is not related to the driving of the vehicle when the user has succeeded in one type of biometric authentication, e.g., face authentication. Further, the apparatus control device 100 permits a user to operate an apparatus related to the driving of the vehicle when the user has succeeded in both of two types of biometric authentication, e.g., face authentication and iris authentication. In the following description, the apparatus control device 100 permits a user to operate the door lock control unit 130 when the user has succeeded in the face authentication, and permits a user to operate the vehicle control ECU 140 when the user has succeeded in both the face authentication and the iris authentication.

Note that the biometric authentication used in the apparatus control device 100 is not limited to face authentication and iris authentication. The apparatus control device 100 may control the operation of an apparatus to be controlled by using biometric authentication selected from fingerprint authentication, palm-print authentication, finger vein authentication, ear acoustic authentication, and the like.

A face image acquisition unit 200 acquires a face image of a user as first biometric information of the user. The face image acquisition unit 200 includes, for example, a camera. The face image acquisition unit 200 includes, for example, a camera provided in the vehicle and configured to photograph a user present outside the vehicle from the inside of the vehicle. Further, the face image acquisition unit 200 includes, for example, a camera that photographs a user sitting on the driver's seat inside the vehicle. The face image acquisition unit 200 may include a camera disposed near a parking space of the vehicle and configured to photograph the vehicle from the outside. The face authentication unit 101 acquires the face image from the face image acquisition unit 200.

The face authentication unit 101 performs face authentication for the face image of the user. The face authentication unit 101 performs face authentication in regard to an operation for unlocking a door performed by a user. Note that “in regard to an operation for unlocking a door performed by a user” includes, for example, a user being performing an operation for unlocking a door, a user being about to perform an operation for unlocking a door, and a user approaching a door for unlocking the door. The face authentication unit 101 performs face authentication when a user performs, for example, an operation for unlocking a door. In other words, the face authentication unit 101 performs face authentication when a user operates the door lock control unit 130. The face authentication unit 101 may perform face authentication when a face is detected in the photographing range of the face image acquisition unit 200. Alternatively, the face authentication unit 101 may perform face authentication when a face is detected within a certain distance from the face image acquisition unit 200.

For example, at least one registrant is registered in the face authentication unit 101 as a user who can (is eligible to) perform an operation for unlocking a door. When the operation for unlocking the door is performed, the face authentication unit 101 compares the face image of the user acquired by the face image acquisition unit 200 with a face image of a registrant (e.g., with each of faces images of registrants) registered therein in advance. The face authentication unit 101 calculates a matching score between the face image of the user and the face image of the registrant (e.g., each of faces images of registrants). The matching score indicates the degree of similarity between the face image of the user and the face image of the registrant. When the matching score meets a predetermined criterion, for example, when the matching score is equal to or higher than a predetermined judging threshold, the face authentication unit 101 determines that the face authentication has succeeded. Further, the face authentication unit 101 specifies, for example, a registrant having the highest matching score as the user who has performed the operation for unlocking the door. The face authentication unit 101 corresponds to the first authentication means 11 shown in FIG. 1.

An iris image acquisition unit 210 acquires an iris image of a user as second biometric information of the user. The iris image acquisition unit 210 includes, for example, a near-infrared light source and a near-infrared camera. The near-infrared light source and the near-infrared camera are disposed, for example, in front of the driver's seat inside the vehicle. The iris image acquisition unit 210 acquires, for example, an iris image of a user sitting on the driver's seat.

The iris authentication unit 102 acquires the iris image from the iris image acquisition unit 210. The iris authentication unit 102 performs iris authentication for the iris image of the user. The iris authentication unit 102 performs iris authentication in regard to an operation for starting the engine or starting a driving system performed by a user. Note that “in regard to an operation for starting the engine or starting a driving system performed by a user” includes, for example, a user being performing an operation for starting the engine, a user being about to perform an operation for starting the engine, and a user being sitting down on the driver's seat. The iris authentication unit 102 performs iris authentication when, for example, a user starts the engine or starts the driving system. In other words, the iris authentication unit 102 performs iris authentication when a user operates the vehicle control ECU 140. The iris authentication unit 102 may perform iris authentication when a face or an eye(s) is detected in the photographing range of the iris image acquisition unit 210. Alternatively, the iris authentication unit 102 may perform iris authentication when a face or an eye(s) is detected within a certain distance from the face image acquisition unit 200.

For example, in the iris authentication unit 102, at least one registrant is registered as a user who can (is eligible to) perform an operation for starting the engine. When the operation for starting the engine is performed, the iris authentication unit 102 compares the iris image of the user acquired by the iris image acquisition unit 210 with an iris image of a registrant (e.g., with each of iris images of registrants) registered therein in advance. The iris authentication unit 102 calculates a matching score between the iris image of the user and the iris image of the registrant (e.g., each of iris images of registrants). The matching score indicates the degree of similarity between the iris image of the user and the iris image of the registrant. When the matching score meets a predetermined criterion, for example, when the matching score is equal to or higher than a predetermined judging threshold, the iris authentication unit 102 determines that the iris authentication has succeeded. Further, the iris authentication unit 102 specifies, for example, a registrant having the highest matching score as the user who has performed the operation for starting the engine. The iris authentication unit 102 corresponds to the second authentication means 12 shown in FIG. 1.

The unification unit 103 unifies the authentication result of the face authentication and the authentication result of the iris authentication. The unification unit 103 determines whether or not a first user who has succeeded in the authentication that was performed by the face authentication unit 101 when the operation for unlocking the door was performed and a second user who has succeeded in the authentication that was performed by the iris authentication unit 102 when the operation for starting the engine was performed are the same person. For example, the unification unit 103 determines whether or not a first registrant who has succeeded in the authentication by the face authentication unit 101 and whose matching score meets a predetermined criterion and a second registrant who has succeeded in the authentication by the iris authentication unit 102 and whose matching score meets a predetermined criterion indicate the same user. When the first and second registrants indicate the same user, the unification unit 103 determines that the first and second users are the same person. When the unification unit 103 determines that both users are the same person, it determines that the second user has already succeeded in the authentication by the face authentication unit 101. When the unification unit 103 determines that both users are not the same person, it makes (e.g., instructs) the face authentication unit 101 perform face authentication for the second user, i.e., the user who has performed the operation for starting the engine and has succeeded in the authentication by the iris authentication unit 102.

When the iris authentication is performed by the iris authentication unit 102 within a predetermined time after the face authentication was performed by the face authentication unit 101, the unification unit 103 may determine whether or not the first and second users are the same person. When the iris authentication is performed after the predetermined time has elapsed after the face authentication was performed, the unification unit 103 may make (i.e., instruct) the face authentication unit 101 perform authentication for the user without determining whether or not the first and second users are the same person.

Further, the unification unit 103 may determine whether or not the first and second users are the same person based on whether or not the user has attempted to illegally pass the face authentication by the face authentication unit 101. Whether or not the user has attempted to illegally pass the face authentication can be determined, for example, based on the posture of the user and his/her belongings. Specifically, when a user holds a photograph of the face of another person, i.e., a photograph of a face of a registrant, toward the face image acquisition unit 200, it is presumed that this user is an illegal user. In this case, the unification unit 103 may determine that the first and second users are not the same person. The unification unit 103 corresponds to the unification means 13 shown in FIG. 1.

An on-board camera 150 is a camera that photographs a user present outside the vehicle and a user present inside the vehicle. The on-board camera 150 is disposed at a position where it can photograph, for example, a user present outside the door of the driver's seat and a user sitting on the driver's seat. The tracking unit 105 acquires a camera image from the on-board camera 150 and tracks the action performed by the user in the camera image. For example, the tracking unit 105 tracks, for example, the movement of a user who has succeeded in the face authentication and unlocked the door. The tracking unit 105 corresponds to the tracking means.

The unification unit 103 may determine, instead of or in addition to the above-described method for determining whether or not the first and second users are the same person, whether or not the first and second users are the same person based on the action performed by the user tracked by the tracking unit 105. For example, the unification unit 103 determines whether or not the user has moved to a place where the iris image acquisition unit 210 acquires an iris image, e.g., moved to the driver's seat, after he/she has succeeded in the face authentication. The unification unit 103 may determine that the first and second users are the same person when the user who has succeeded in the face authentication has moved to the driver's seat and the iris authentication unit 102 performs the iris authentication.

When the user has succeeded in the face authentication by the face authentication unit 101, the apparatus control unit 104 permits the user to perform an operation for unlocking the door. The apparatus control unit 104 restricts the operation of the door lock control unit 130 until, for example, the user succeeds in the face authentication. When the user has succeeded in the face authentication, the apparatus control unit 104 receives a signal indicating that the door can be unlocked to the door lock control unit 130. When the door lock control unit 130 receives the signal indicating that the door can be unlocked, it unlocks the door when, for example, the user touches a door knob or the user presses a button provided near the door knob.

Further, when the user has succeeded in the face authentication by the face authentication unit 101 and succeeded in the iris authentication by the iris authentication unit 102, the apparatus control unit 104 permits the user to perform the operation for starting the engine. The apparatus control unit 104 restricts the operation of the vehicle control ECU 140 until, for example, the user succeeds in the face authentication and the iris authentication. In this example embodiment, the user must have succeeded in the face authentication as well as the iris authentication when he/she starts the engine. The user may have already succeeded in the face authentication when he/she performed the operation for unlocking the door, or may have succeeded in the face authentication performed when he/she performs the operation for starting the engine. When the user has succeeded in both the face authentication and the iris authentication, the apparatus control unit 104 transmits a signal indicating that the engine can be started to the vehicle control ECU 140. The vehicle control ECU 140 starts the engine when the user presses a button for starting the engine provided near the driver's seat. The apparatus control unit 104 corresponds to the control means 14 shown in FIG. 1.

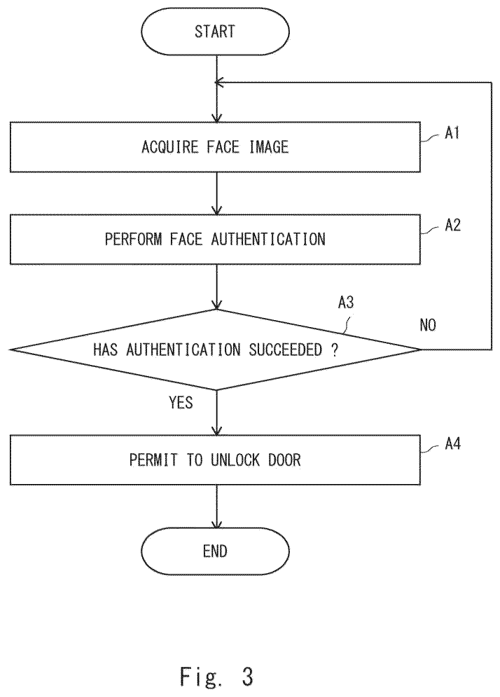

Next, a procedure of operations performed by the apparatus control device 100 including an apparatus control method and an authentication method will be described. FIG. 3 shows a procedure of operations performed by the apparatus control device 100 when a door is unlocked. The face image acquisition unit 200 acquires a face image of a user (Step A1). The face image acquisition unit 200 acquires a face image of, for example, a person approaching a door of the vehicle and transmits the acquired face image to the face authentication unit 101. The face authentication unit 101 performs face authentication for the face image acquired in the step A1 (Step A2). In the step A2, the face authentication unit 101 compares, for example, the face image acquired in the step A1 with each of face images of registrants and calculates a matching score for each of the face images of the registrants.

The face authentication unit 101 determines whether or not the face authentication has succeeded (Step A3). The face authentication unit 101 determines that the face authentication has succeeded when, for example, the matching score is equal to or higher than a judging threshold. When the face authentication has succeeded, the face authentication unit 101 specifies which of the registrants the user is. When the matching score is lower than the judging threshold, the face authentication unit 101 determines that the face authentication has failed. When it is determined that the face authentication has failed in the step A3, the process returns to the step A1 and a face image is acquired.

When it is determined that the face authentication has succeeded in the step A3, the unification unit 103 transmits an authentication result indicating that the user has succeeded in the face authentication to the apparatus control unit 104. When the user has succeeded in the face authentication, the apparatus control unit 104 transmits a signal indicating that the door can be unlocked to the door lock control unit 130. When the door lock control unit 130 receives the signal indicating that the door can be unlocked, it unlocks the door in response to an operation performed by the user (Step A4).

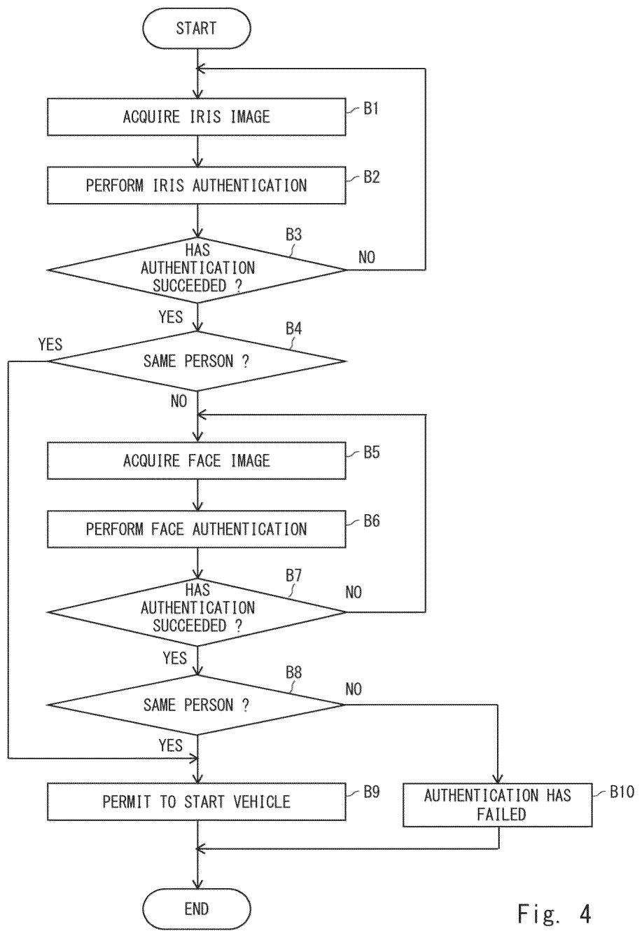

FIG. 4 shows a procedure of operations performed by the apparatus control device 100 when the engine is started. The iris image acquisition unit 210 acquires an iris image of a user (Step B1). The iris image acquisition unit 210 acquires an iris image of, for example, a person sitting on the driver's seat and transmits the acquired iris image to the iris authentication unit 102. The iris authentication unit 102 performs iris authentication for the iris image acquired in the step B1 (Step B2). In the step B2, the iris authentication unit 102 compares, for example, the iris image acquired in the step B1 with each of iris images of registrants and calculates a matching score for each of the iris images of the registrants.

The iris authentication unit 102 determines whether or not the iris authentication has succeeded (Step B3). The iris authentication unit 102 determines that the iris authentication has succeeded when, for example, the matching score is equal to or higher than a judging threshold. When the iris authentication has succeeded, the iris authentication unit 102 specifies which of the registrants the user is. When the matching score is lower than the judging threshold, the iris authentication unit 102 determines that the iris authentication has failed. When it is determined that the iris authentication has failed in the step B3, the process returns to the step Bl and an iris image is acquired.

When it is determined that the iris authentication has succeeded in the step B3, the unification unit 103 determines whether or not the user who has succeeded in the face authentication in regard to the unlocking of the door and the user who has succeeded in the iris authentication in the step B2 are the same person (Step B4). When the unification unit 103 determines that both users are the same person, it transmits an authentication result indicating that the user has succeeded in both the face authentication and the iris authentication to the apparatus control unit 104. When the user has succeeded in both the face authentication and the iris authentication, the apparatus control unit 104 transmits a signal indicating that the engine can be started to the vehicle control ECU 140 (Step B9). When the vehicle control ECU 140 receives the signal indicating that the engine can be started, it starts the engine in response to an operation performed by the user.

When it is not determined that both users are the same person in the step B4, the unification unit 103 makes (e.g., instructs) the face authentication unit 101 perform face authentication. In this case, the face image acquisition unit 200 acquires a face image of the user (Step B5). In the step B5, the face image acquisition unit 200 acquires the face image of the person sitting on the driver's seat and transmits the acquired face image to the face authentication unit 101. The face authentication unit 101 performs face authentication for the face image acquired in the step B5 (Step B6).

The face authentication unit 101 determines whether or not the face authentication has succeeded (Step B7). The face authentication unit 101 determines that the face authentication has succeeded when, for example, the matching score is equal to or higher than a judging threshold. When the face authentication has succeeded, the face authentication unit 101 specifies which of the registrants the user is. When the matching score is lower than the judging threshold, the face authentication unit 101 determines that the face authentication has failed. When it is determined that the face authentication has failed in the step A3, the process returns to the step B5 and a face image is acquired.

When it is determined that the face authentication has succeeded in the step B7, the unification unit 103 determines whether or not the user who has succeeded in the authentication through the iris authentication in the step B2 and the user who has succeeded in the authentication through the face authentication in the step B6 are the same person (Step B8). When the unification unit 103 determines that both users are the same person, it transmits an authentication result indicating that the user has succeeded in both the face authentication and the iris authentication to the apparatus control unit 104. After that, the process proceeds to the step B9, and the apparatus control unit 104 transmits a signal indicating that the engine can be started to the vehicle control ECU 140.

When it is determined that both users are not the same person in the step B8, the unification unit 103 transmits a signal indicating that the authentication has failed to the apparatus control unit 104 (Step B10). In this case, the apparatus control unit 104 does not transmit a signal indicating that the engine can be started to the vehicle control ECU 140, and hence the vehicle control ECU 140 does not permit the user to start the engine.

In this example embodiment, the face authentication unit 101 authenticates a user through face authentication when the user unlocks (i.e., tries to unlock) a door. When the user has succeeded in the face authentication by the face authentication unit 101, the apparatus control unit 104 transmits a signal indicating that the door can be unlocked to the door lock control unit 130. Further, the iris authentication unit 102 authenticates a user through iris authentication when the user starts (i.e., tries to unlock) the engine. When the user has succeeded in the iris authentication, the unification unit 103 determines whether or not the user who has succeeded in the iris authentication is the same person as the user who has succeeded in the face authentication in regard to the unlocking of the door. When the unification unit 103 determines that both users are the same person, it determines that the user also has already succeeded in the face authentication. In this case, the apparatus control unit 104 transmits a signal indicating that the engine can be started to the vehicle control ECU 140.

In the case where the results of the face authentication and the iris authentication are not unified, for example, a user other than the driver can unlock the door through the face authentication, and then the driver performs the iris authentication and thereby can start the engine. However, in that case, the driver has performed only the iris authentication, so that the biometric authentication is not multimodal. On the other hand, if face authentication is always required when the engine is started, the driver who has unlocked the door through the face authentication needs to perform face authentication again, and as a result, the usability for users decreases.

In this example embodiment, when a user who has succeeded in the face authentication when he/she unlocked a door and a user who has succeeded in the iris authentication when he/she tries to start the engine are the same person, the unification unit 103 determines that the user has succeeded in the two types of biometric authentication. In that case, the face authentication, which would otherwise need to be performed when the engine is started, can be omitted. In this example embodiment, when the engine is started, the face authentication is performed only when both users are not the same person. As a result, it is possible to prevent the face authentication is performed twice for one person. In this example embodiment, it is possible to ensure that a user has succeeded in a plurality of types of biometric authentication when he/she starts the engine. Therefore, it is possible to permit the user to start the engine only when he/she has succeeded in two types of biometric authentication while preventing the usability for users from decreasing.

Note that in the above-described example embodiment, an example in which the apparatus control device 100 performs all of the face authentication, the iris authentication, and the control of apparatuses has been described. However, the present disclosure is not limited to such an example. The apparatus control device 100 does not necessarily have to be one apparatus. The apparatus control device 100 may be formed by a plurality of physically separated apparatuses. Some of the functions of the apparatus control device 100 may be performed by, for example, another device such as a cloud server. For example, the functions of the face authentication unit 101 and the iris authentication unit 102 may be implemented in a cloud server, and the unification unit 103 may acquire authentication results from the cloud server.

In the above-described example embodiment, an example in which the apparatus control unit 104 performs control in regard to the unlocking of a door and the start of the engine by using authentication results has been described. However, the present disclosure is not limited to such an example. It is sufficient if the apparatus control unit 104 controls a plurality of apparatuses the numbers of types of authentications required by which differ from each other, and the apparatuses to be controlled are not limited to any particular apparatuses. Further, the apparatuses to be controlled are not limited to apparatuses of vehicles.

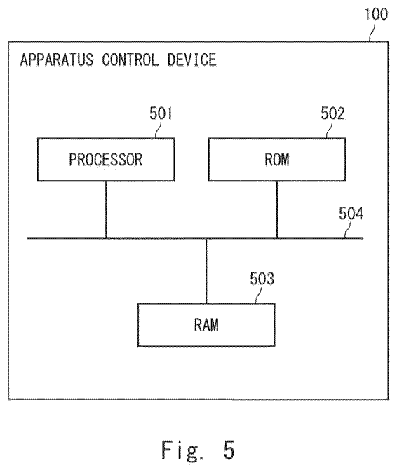

Next, a hardware configuration of the apparatus control device 100 will be described. FIG. 5 shows an example of the hardware configuration of the apparatus control device 100. The apparatus control device 100 includes a processor (CPU: Central Processing Unit) 501, a ROM (read only memory) 502, and a RAM (random access memory) 503. In the apparatus control device 100, the processor 501, the ROM 502, and the RAM 503 are connected to each other through a bus 504. The apparatus control device 100 may include other circuits such as peripheral circuits, communication circuits, and interface circuits, though they are not shown in the drawings.

The ROM 502 is a nonvolatile storage device. For the ROM 502, a semiconductor storage device such as a flash memory having a relatively small capacity is used. The ROM 502 stores a program(s) to be executed by the processor 501.

The above-described program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a RAM, a ROM, a flash memory, a solid-state drive (SSD), or other memory technology, a Compact Disc (CD), digital versatile disc (DVD), Blu-ray (Registered Trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

The RAM 503 is a volatile storage device. As the RAM 503, various types of semiconductor memory apparatuses such as a DRAM (Dynamic Random Access Memory) or an SRAM (Static Random Access Memory) can be used. The RAM 503 can be used as an internal buffer for temporarily storing data or the like.

The processor 501 expands (i.e., loads) a program stored in the ROM 502 in the RAM 503, and executes the expanded (i.e., loaded) program. As the CPU 501 executes the program, the function of each unit of the apparatus control device 100 can be implemented.

Although example embodiments according to the present disclosure have been described above in detail, the present disclosure is not limited to the above-described example embodiments, and the present disclosure also includes those that are obtained by making changes or modifications to the above-described example embodiments without departing from the scope of the present disclosure.

The whole or part of the example embodiments disclosed above can be described as, but not limited to, the following Supplementary notes.

### [Supplementary Note 1]

An apparatus control device including:
control means for controlling a first apparatus and a second apparatus;
first authentication means for authenticating a user by using first biometric information;
second authentication means for authenticating a user by using second biometric information; and
unification means for unifying an authentication result of the first authentication means with an authentication result of the second authentication means, wherein
the control means permits the first apparatus to be operated when the user has succeeded in the authentication by the first authentication means, and permits the second apparatus to be operated when the user has succeeded in the authentication by the first authentication means and succeeded in the authentication by the second authentication means,
the first authentication means performs the authentication of the user in regard to the operation of the first apparatus,
the second authentication means performs the authentication of the user in regard to the operation of the second apparatus, and
the unification means determines whether or not a first user who has succeeded in the authentication performed by the first authentication means in regard to the operation of the first apparatus and a second user who has succeeded in the authentication performed by the second authentication means in regard to the operation of the second apparatus are the same person, and determines that the second user has already succeeded in the authentication by the first authentication means when it is determined that the first and second users are the same person.

### [Supplementary Note 2]

The apparatus control device described in Supplementary note 1, wherein when the first and second users are not the same person, the unification means makes the first authentication means authenticate the user.

### [Supplementary Note 3]

The apparatus control device described in Supplementary note 1 or 2, wherein the first apparatus is an apparatus that is not related to driving of the vehicle in the vehicle and the second apparatus is an apparatus related to the driving of the vehicle in the vehicle.

### [Supplementary Note 4]

The apparatus control device described in any one of Supplementary notes 1 to 3, wherein the first authentication means authenticates the user by using the first biometric information acquired outside the vehicle.

### [Supplementary Note 5]

The apparatus control device described in any one of Supplementary notes 1 to 4, wherein the second authentication means authenticates the user by using the second biometric information acquired inside the vehicle.

### [Supplementary Note 6]

The apparatus control device described in any one of Supplementary notes 1 to 5, wherein
the first authentication means compares the first biometric information acquired from the user in regard to the operation of the first apparatus with the first biometric information of at least one first registrant registered as a user who can operate the first apparatus, and determines that the authentication has succeeded when a matching score indicating a degree of similarity between the first biometric information acquired from the user and the first biometric information of the first registrant meets a predetermined criterion,
the second authentication means compares the second biometric information acquired from the user in regard to the operation of the second apparatus with the second biometric information of at least one second registrant registered as a user who can operate the second apparatus, and determines that the authentication has succeeded when a matching score indicating a degree of similarity between the second biometric information acquired from the user and the second biometric information of the second registrant meets a predetermined criterion, and
the unification means determines that the first and second users are the same person when the first registrant whose matching score meets the predetermined criterion in the first authentication means and the second registrant whose matching score meets the predetermined criterion in the second authentication means indicate the same user.

### [Supplementary Note 7]

The apparatus control device described in any one of Supplementary notes 1 to 6, wherein when the authentication is performed by the second authentication means within a predetermined time after the authentication is performed by the first authentication means, the unification means determines whether or not the first and second users are the same person.

### [Supplementary Note 8]

The apparatus control device described in any one of Supplementary notes 1 to 7, further including tracking means for tracking an action of the first user, wherein
the unification means determines that the first and second users are the same person when the first user has moved to a place where the second biometric information is acquired and the second authentication means has authenticated the user.

### [Supplementary Notes 9]

The apparatus control device described in any one of Supplementary notes 1 to 8, wherein the unification means determines whether or not the first and second users are the same person based on whether or not the user has attempted to illegally pass the authentication by the first authentication means.

### [Supplementary Notes 10]

The apparatus control device described in any one of Supplementary notes 1 to 9, wherein the control means restricts the operation of the first apparatus until the user succeeds in the authentication by the first authentication means, and restricts the operation of the second apparatus until the user succeeds in the authentication by the first authentication means and succeeds in the authentication by the second authentication means.

### [Supplementary Note 11]

An authentication device including:
first authentication means for authenticating a user in regard to an operation of a first apparatus by using first biometric information;
second authentication means for authenticating a user in regard to an operation of a second apparatus by using second biometric information; and
unification means for unifying an authentication result of the first authentication means with an authentication result of the second authentication means, wherein
the first apparatus is an apparatus that is permitted to be operated when the first authentication means has succeeded in the authentication, and the second apparatus is an apparatus that is permitted to be operated when the first authentication means has succeeded in the authentication and the second authentication means has succeeded in the authentication, and
the unification means determines that, when a first user who has succeeded in the authentication performed by the first authentication means in regard to the operation of the first apparatus and a second user who has succeeded in the authentication performed by the second authentication means in regard to the operation of the second apparatus are the same person, the second user has already succeeded the authentication by the first authentication means.

### [Supplementary Note 12]

The authentication device described in Supplementary note 11, wherein when the first and second users are not the same person, the unification means makes the first authentication means authenticate the user.

### [Supplementary Note 13]

The authentication device described in Supplementary note 11 or 12, wherein the first authentication means authenticates the user by using the first biometric information acquired outside the vehicle.

### [Supplementary Note 14]

The authentication device described in any one of Supplementary notes 11 to 13, wherein the second authentication means authenticates the user by using the second biometric information acquired inside the vehicle.

### [Supplementary Note 15]

An apparatus control method including:
authenticating a user in regard to an operation of a first apparatus by using first biometric information;
permitting the user to operate the first apparatus when the user has succeeded in the authentication using the first biometric information;
authenticating a user in regard to an operation of a second apparatus by using second biometric information;
determining whether or not a first user who has succeeded in the authentication performed in regard to the operation of the first apparatus by using the first biometric information and a second user who has succeeded in the authentication performed in regard to the operation of the second apparatus by using the second biometric information are the same person; and
permitting the second user to operate the second apparatus when it is determined the first and second users are the same person.

### [Supplementary Note 16]

An authentication method including:
authenticating a user in regard to an operation of a first apparatus by using first biometric information, the first apparatus being configured to be permitted to be operated when the authentication using the first biometric information has succeeded;
authenticating a user in regard to an operation of a second apparatus by using second biometric information, the second apparatus being configured to be permitted to be operated when the authentication using the first biometric information and the authentication using the second biometric information have succeeded;
determining whether or not a first user who has succeeded in the authentication performed in regard to the operation of the first apparatus by using the first biometric information and a second user who has succeeded in the authentication performed in regard to the operation of the second apparatus by using the second biometric information are the same person; and
determining that the second user has already succeeded in the authentication using the first biometric information when it is determined the first and second users are the same person.

### [Supplementary Note 17]

A non-transitory computer readable medium storing a program for causing a computer to perform processes including:
authenticating a user in regard to an operation of a first apparatus by using first biometric information;
permitting the user to operate the first apparatus when the user has succeeded in the authentication using the first biometric information;
authenticating a user in regard to an operation of a second apparatus by using second biometric information;
determining whether or not a first user who has succeeded in the authentication performed in regard to the operation of the first apparatus by using the first biometric information and a second user who has succeeded in the authentication performed in regard to the operation of the second apparatus by using the second biometric information are the same person; and
permitting the second user to operate the second apparatus when it is determined the first and second users are the same person.

### [Supplementary Note 18]

A non-transitory computer readable medium storing a program for causing a computer to perform processes including:
authenticating a user in regard to an operation of a first apparatus by using first biometric information, the first apparatus being configured to be permitted to be operated when the authentication using the first biometric information has
authenticating a user in regard to an operation of a second apparatus by using second biometric information, the second apparatus being configured to be permitted to be operated when the authentication using the first biometric information and the authentication using the second biometric information have succeeded;
determining whether or not a first user who has succeeded in the authentication performed in regard to the operation of the first apparatus by using the first biometric information and a second user who has succeeded in the authentication performed in regard to the operation of the second apparatus by using the second biometric information are the same person; and
determining that the second user has already succeeded in the authentication using the first biometric information when it is determined the first and second users are the same person.

### REFERENCE SIGNS LIST

10 APPARATUS CONTROL DEVICE
11 FIRST AUTHENTICATION MEANS
12 SECOND AUTHENTICATION MEANS
13 UNIFICATION MEANS
14 CONTROL MEANS
20 AUTHENTICATION DEVICE
30 FIRST APPARATUS
40 SECOND APPARATUS
100 APPARATUS CONTROL DEVICE
101 FACE AUTHENTICATION UNIT
102 IRIS AUTHENTICATION UNIT
103 UNIFICATION UNIT
104 APPARATUS CONTROL UNIT
105 TRACKING UNIT
120 AUTHENTICATION DEVICE
130 DOOR LOCK CONTROL UNIT
140 VEHICLE CONTROL ECU
200 FACE IMAGE ACQUISITION UNIT
210 IRIS IMAGE ACQUISITION UNIT

What is claimed is:

1. An apparatus control device comprising:
at least one memory storing instructions; and
at least one processor configured to execute the instructions to:
perform first authentication to authenticate a user in regard to an operation of a first apparatus by using first biometric information;
perform second authentication to authenticate a user in regard to an operation of a second apparatus by using second biometric information;
determine whether or not a first user who has successfully authenticated in the first authentication performed in regard to the operation of the first apparatus and a second user who has successfully authenticated in the second authentication performed in regard to the operation of the second apparatus are the same person;
determine that the second user has already successfully authenticated in the first authentication when it is determined that the first and second users are the same person;
permit the first apparatus to be operated when the user has succeeded successfully authenticated in the first authentication; and
permit permits the second apparatus to be operated when the user has succeeded successfully authenticated in the first authentication and in the second authentication.

2. The apparatus control device according to claim 1, wherein when the first and second users are not the same person, the at least one processor is configured to execute the instructions to perform third authentication to authenticate the user by using the first biometric information.

3. The apparatus control device according to claim 1, wherein the first apparatus is an apparatus that is not related to driving of the vehicle in the vehicle and the second apparatus is an apparatus related to the driving of the vehicle in the vehicle.

4. The apparatus control device according to claim 1, wherein the at least one processor is configured to execute the instructions to authenticate the user in the first authentication by using the first biometric information acquired outside the vehicle.

5. The apparatus control device according to claim 1, wherein the at least one processor is configured to execute the instructions to authenticate the user in the second authentication by using the second biometric information acquired inside the vehicle.

6. The apparatus control device according to claim 1, wherein the at least one processor is configured to execute the instructions to:
compare the first biometric information acquired from the user in regard to the operation of the first apparatus with the first biometric information of at least one first registrant registered as a user who can operate the first apparatus, and determine that the user has successfully authenticated in the first authentication when a matching score indicating a degree of similarity between the first biometric information acquired from the user and the first biometric information of the first registrant meets a predetermined criterion,
compare the second biometric information acquired from the user in regard to the operation of the second apparatus with the second biometric information of at least one second registrant registered as a user who can operate the second apparatus, and determine that the user has successfully authenticated in the second authentication when a matching score indicating a degree of similarity between the second biometric information acquired from the user and the second biometric information of the second registrant meets a predetermined criterion, and
determine that the first and second users are the same person when the first registrant whose matching score meets the predetermined criterion in the first authentication and the second registrant whose matching score meets the predetermined criterion in the second authentication indicate the same user.

7. The apparatus control device according to claim 1, wherein when the second authentication is performed within a predetermined time after the first authentication is performed, the at least one processor is configured to execute the instructions to determine whether or not the first and second users are the same person.

8. The apparatus control device according to claim 1, wherein the at least one processor is configured to execute the instructions to:
track an action of the first user, and
determine that the first and second users are the same person when the first user has moved to a place where the second biometric information is acquired and the user has successfully authenticated in the second authentication.

9. The apparatus control device according to claim 1, wherein the at least one processor is configured to execute the instructions to determine whether or not the first and second users are the same person based on whether or not the user has attempted to illegally pass the first authentication.

10. The apparatus control device according to claim 1, wherein the at least one processor is configured to execute the instructions to restrict the operation of the first apparatus until the user successfully authenticates in the first authentication, and restrict the operation of the second apparatus until the user successfully authenticates in the first authentication and in the second authentication.

11.-14. (canceled)

15. An apparatus control method comprising:
authenticating a user in regard to an operation of a first apparatus by using first biometric information;
permitting the user to operate the first apparatus when the user has succeeded in the authentication using the first biometric information;
authenticating a user in regard to an operation of a second apparatus by using second biometric information;
determining whether or not a first user who has succeeded in the authentication performed in regard to the operation of the first apparatus by using the first biometric information and a second user who has succeeded in the authentication performed in regard to the operation of the second apparatus by using the second biometric information are the same person; and
permitting the second user to operate the second apparatus when it is determined the first and second users are the same person.

16. An authentication method comprising:
authenticating a user in regard to an operation of a first apparatus by using first biometric information, the first apparatus being configured to be permitted to be operated when the authentication using the first biometric information has succeeded;
authenticating a user in regard to an operation of a second apparatus by using second biometric information, the second apparatus being configured to be permitted to be operated when the authentication using the first biometric information and the authentication using the second biometric information have succeeded;
determining whether or not a first user who has succeeded in the authentication performed in regard to the operation of the first apparatus by using the first biometric information and a second user who has succeeded in the authentication performed in regard to the operation of the second apparatus by using the second biometric information are the same person; and
determining that the second user has already succeeded in the authentication using the first biometric information when it is determined the first and second users are the same person.

17.-18. (canceled)
